(19) United States
(12) Patent Application Publication
(10) Pub. No.: US 2011/0286685 A1
(43) Pub. Date: Nov. 24, 2011

(54) IMAGE FORMATION METHOD AND IMAGE FORMATION DEVICE

(76) Inventors: Makoto Nishihara, Hitachinaka (JP); Kyoungmo Yang, Mito (JP); Yoshihiro Oyabu, Yokohama (JP)

(21) Appl. No.: 13/131,750

(22) PCT Filed: Oct. 15, 2009
(86) PCT No.: PCT/JP2009/005374

§ 371 Date: Aug. 5, 2011

(30) Foreign Application Priority Data
Nov. 28, 2008 (JP) 2008-303378

(51) Int. Cl. G06K 9/36

(52) U.S. Cl. 382/286

(57) ABSTRACT

Provided are an image formation method and a charged particle beam device which can accurately measure a plurality of objects to be measured and contained in an image by executing a small number of scans. For this, a scan line is set in a direction other than the edge direction of a plurality of objects to be measured and contained in the image view field and the charged particle beam is scanned according to the setting. Provided also are a method and a device for setting a scan line direction in an appropriate direction not affected by the pattern deformation or the like. For this, a direction of disconnection between two patterns to be connected is obtained according to the deformation of the two patterns and a scan line is set in the direction determined according to the one of more directions of disconnection.

### TECHNICAL FIELD

The present invention relates to an image formation method and an image formation device for forming images based on scanning of a charged particle beam and more particularly, to a method and a device for forming an image by rotating the scan direction.

### BACKGROUND ART

A charged particle beam device represented by a scanning electron microscope is a device for forming an image based on charged particles emitted from a sample under scanning of a charged particle beam. The image formed by the charged particle beam device is expressed by a contrast generated by the fact that the amount of secondary electrons or the like emitted from the sample changes within an area of scanning of the charged particle beam.

It is known, in order to clearly express the contrast as above, the scan direction is adjusted so that the scan line path of the charged particle beam is normal to the edge direction of a pattern. With the beam scanned in the direction normal to the edge, contrast between an edge portion and the other portions can be clarified by virtue of the edge effect and an image emphasized at the edge portion throughout the overall image can be formed.

In Patent Literature 1 (FIG. 15 and FIG. 16) a so-called raster rotation technique is described in which the scan direction is rotated in order that the scanning line direction can be parallel to a direction normal to the edge in respect of each of the two patterns when patterns extending in the vertical direction (X direction) and the horizontal direction are present.

### CITATION LIST

### Patent Literature

Patent Literature 1: JP-A-2007-59370 (corresponding to U.S. Pat. No. 7,187,345)

### SUMMARY OF INVENTION

### Technical Problem

The technique for rotation of scan direction based on the raster rotation as disclosed in Patent Literature 1 exhibits an advantageous effect in that highly accurate measurement can be performed for patterns having longitudinal directions in a plurality of different directions. However, when a plurality of different measurement object patterns are contained in the scanning area of the electron beam, the raster rotation needs to be carried out plural times in the respective directions of pattern edges. When a plurality of measurement objects of different edge directions are present in a narrow area, the raster rotation repetitively conducted plural times to scan the beam plural times on the same area gives rise to a concern that a sample will be damaged in the case the sample is susceptible to the electron beam irradiation.

An image formation method and a charged particle beam device which are intended to accurately perform measurement of a plurality of objects contained in an image through a less number of scanning operations are described hereinafter. Further, a method and a device which are intended to set a scan direction in an appropriate direction independent of pattern deformation and the like are described.

### Solution to Problem

As a method and a device for attaining the first objective described above, an image formation method and an image formation device are proposed in which the scanning line direction is set in a direction other than edge directions of a plurality of measurement objects contained in an image field of view and a charged particle beam is scanned based on the setting.

As a method and a device for attaining the second objective, an image formation method and an image formation device are proposed in which a direction of interruption between two patterns is determined in accordance with deformations of the two patterns to be connected and the scanning line is set in a direction determined based on determination of the direction of interruption or the directions of a plurality of interruptions.

### Advantageous Effects of Invention

With the aforementioned configuration, highly accurate measurements can be achieved through a less number of beam scanning operations even when a plurality of measurement objects having different directions of measurement object edges are present inside a scan area of the charged particle beam or even when the direction of interruption between connecting patterns changes due to pattern deformation or the like.

### BRIEF DESCRIPTION OF DRAWINGS

FIG. 1 is a schematic diagram illustrating construction of a scanning electron microscope.

FIG. 2 is a diagram for explaining a layout of patterns and an SEM image obtained by scanning a beam on the patterns.

FIG. 3 is a diagram for explaining a layout of patterns and an SEM image obtained by inclining the scanning line direction with respect to edges of the patterns.

FIG. 4 is a diagram for explaining an example where an SEM image attainable when the scanning line direction is not rotated is reproduced by rotating an image obtained through rotation of the scanning line direction by an image processing unit.

FIG. 5 is a diagram for explaining an example of layout of patterns with pattern edges having their longitudinal directions inclined to the horizontal direction by 45 degrees.

FIG. 6 is a diagram for explaining an example of scanning line direction when an SEM image is obtained by rotating the scanning line direction with respect to a pattern having its pattern edge directed in 45-degrees direction.

FIG. 7 is a diagram for explaining an image obtained when the scanning line direction is rotated and an image rotated through image processing as to become an image before rotation of the scanning line direction.

FIG. 8 is a flowchart for explaining a magnification error correction process during raster rotation.

FIG. 9 is a diagram for explaining a method of cutting out part of an image after raster rotation and image processing.

FIG. 10 is a diagram for explaining the outline of a measurement system including the SEM.

FIG. 11 is a diagram for explaining a method of designating a plurality of measurement spots in design data.

FIG. 12 is a flowchart showing a process of automatically determining the scanning line direction based on a plurality of measurement spots in the design data.

FIG. 13 is a flowchart for explaining a process of multiplying an obtained length measurement value by a correction coefficient during length measurement.

FIG. 14 is a diagram for explaining an example of design data of a pattern formed through double exposure.

FIG. 15 is a diagram for explaining an example of an SEM image of a pattern formed through double exposure.

FIG. 16 is a diagram for explaining an example where connection status of two patterns changes due to deformations of the patterns and the like.

FIG. 17 is a diagram for explaining an example where connection between patterns is not properly conducted.

FIG. 18 is a flowchart for explaining a process for deciding the direction of interruption between patterns.

FIG. 19 is a diagram for explaining the outline of a measurement system including SEM's.

### DESCRIPTION OF EMBODIMENTS

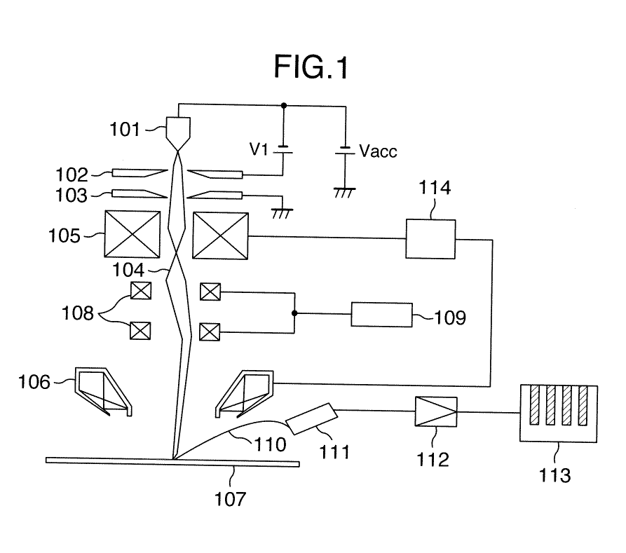

Schematic construction of a scanning electron microscope (SEM) embodying a charged particle beam device is exemplified in FIG. 1. A primary electron beam 104 generated by a cathode 101 and a first anode 102 is accelerated by voltage Vacc applied to a second anode 103 so as to travel to a lens system of the succeeding stage. The primary electron beam 104 is focused to a fine spot on a wafer (sample) 107 by a condenser lens 105 and an objective lens 106 which are controlled by a lens control power supply 114 and is then scanned two-dimensionally on the wafer (sample) 107 by two-stage deflection coil 108. A scan signal for the deflection coil 108 is controlled according to an observation magnification by a deflection controller 109. Secondary electrons 110 generated from the sample by the primary electron beam 104 scanning on the wafer (sample) 107 are detected with a secondary electron detector 111. Information of secondary electrons detected with the secondary electron detector 111 is amplified by an amplifier 112 and displayed on a CRT 113. In the present invention, automatic measurement of patterns is carried out by utilizing information of a sample shape displayed on the CRT 113.

For scanning of the electron beam, an electrostatic deflector may also be used. Further, in the device of the present embodiment, the function of scan rotation to rotate the scan direction of the scan deflector is provided.

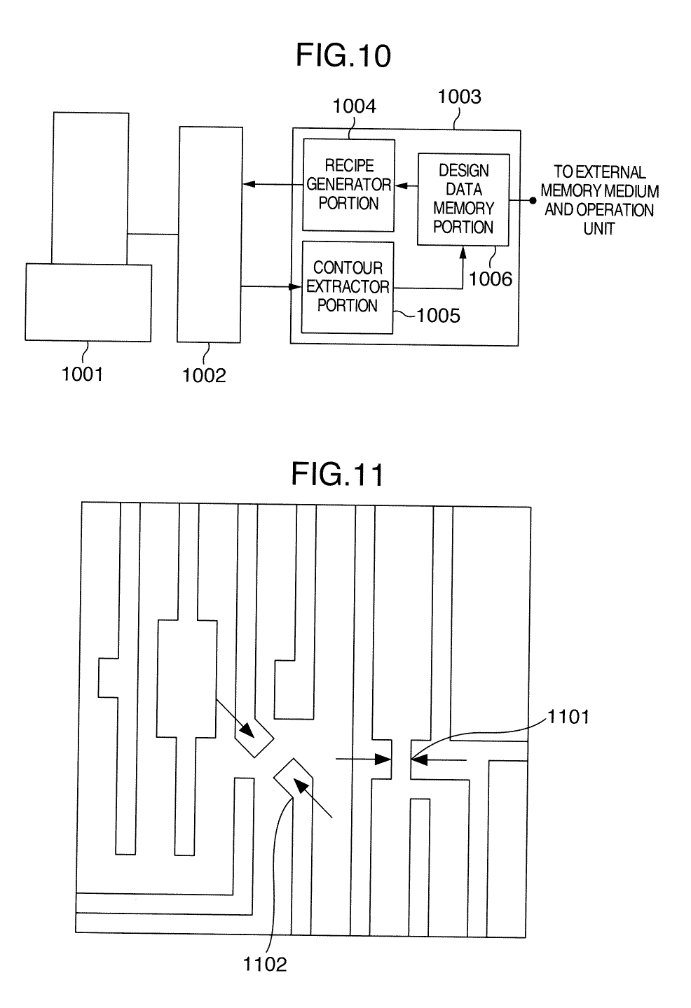

FIG. 10 is a diagram for explaining an example of configuration of a measurement system including the SEM exemplified in FIG. 1. The SEM 1001 is connected with a control unit 1002 for controlling the individual constituents of the SEM explained with FIG. 1 and the controller 1002 is in turn connected with a data management unit 1003. The data management unit 1003 is supplied with a design data memory portion 1006 adapted to store design data of a semiconductor device and a recipe generator portion 1004 adapted to set a recipe based on the design data stored in the design data memory portion 1006.

A recipe is a program for setting operating conditions of the SEM and the SEM conducts measurement of a sample based on operating conditions set in the recipe. The recipe generator portion 1004 is programmed to generate a recipe so that a field of view (FOV) of the electron beam is positioned at a desired measurement spot of the sample based on coordinate information specified in the design data.

In the control unit 1002, control necessary for the SEM 1001 is carried out. In the SEM 1001, an electron beam emitted from the electron source is focused by the plural stages of lenses and the focused electron beam is scanned one-dimensionally or two-dimensionally on the sample by the scan deflector.

Secondary electrons (SE's) or backscattered electrons (BSE's) emitted from the sample under the electron beam scanning are detected by the detector and stored in the memory medium such as a frame memory in synchronism with the scanning by the scan deflector.

Further, the scanning by the scan deflector can be conducted over any size, at any position, and in any direction, permitting execution of scanning for formation of images and selective scanning to edge portions as described later.

The control as above and the like are conducted in the control unit 1002 and an image and a signal obtained as a result of the scanning of electron beam is sent to the data management unit 1003. In the present example the control unit for controlling the SEM and the data management unit for performing measurement based on the signal obtained by the SEM are described as being separate from each other but it is not limited thereof; the device control and the measurement processing may be executed collectively in the data management unit or the SEM control and the measurement processing may be executed in each control unit. Alternatively, design data may be stored in another design data management unit and may be accessed from the data management unit as needed to read out necessary design data.

Then, the aforementioned data management unit or the control unit (hereinafter, sometimes referred to as an image processing unit) stores a program for execution of the measurement processing and is provided with an operation unit which performs an operation to be described later in accordance with the program, thus permitting measurement to be performed in accordance with the program. Further, in the design data management unit, design data of photo-masks used in semiconductor fabrication process (hereinafter, simply referred sometimes to as masks) and wafers are stored. The design data are expressed in a GDS format or an OASIS format, for example, and stored in a predetermined format. The kind of the design data does not matter, provided that software for displaying the design data can display one in its format type and handle it as graphic data. In an alternative, the design data may be stored in a memory medium provided separately from the data management unit.

Incidentally, the aforementioned data management unit or the design data management unit may incorporate a simulator of a pattern formed after lithography based on design data of a semiconductor pattern. The thus simulated pattern profile is stored in a predetermined format in the aforementioned data management unit, the design data management unit, or the like. Further, the above simulation may be executed by an external computer and the result may be read out by accessing the data management unit and stored in the design data memory portion 1006.

### Embodiment 1

The SEM adapted to perform measurement and observation of a pattern formed on a semiconductor wafer and of a photo-mask for exposure of the pattern is a device which detects electrons obtained by scanning an electron beam one-dimensionally or two-dimensionally on a sample and forms an image and a line profile. In the two-dimensional scanning of the electron beam, the electron beam is scanned such that the scanning line is traced linearly in the X direction (or the Y direction) and besides the scanning line is shifted in the Y direction (or the X direction).

A critical dimension scanning electron microscope (CD-SEM) is of one kind of SEM which is adapted to measure dimensions of a pattern based on a line profile formed based on scanning of an electron beam. The line profile is a waveform indicating changes of brightness within an FOV and, for example, when scanning is done on a line pattern lying in the horizontal direction (a pattern having the scanning line and a pattern edge parallel with each other), a waveform in which a change in brightness hardly appears is obtained. Consequently, identification of an edge position is difficult and reproducibility of length measurement is sometimes degraded.

Against the problem such as the above, it is conceivable that the scan direction of electron beam is changed by 90 degrees when a length of a line pattern lying in the horizontal direction is measured. By changing the scan direction by 90 degrees, the scan direction of the electron beam becomes normal to the pattern edge and differences in brightness between the edge portion and the other sections can be clarified by virtue of the edge effect. Accordingly, an SEM image can be distinct at the edge portion and the edge detection position can be stable, preventing the measurement reproducibility from being degraded.

When one-dimensional dimension measurement such as the line pattern in the vertical direction or horizontal direction is performed, it is conceivable that the function of the raster rotation can be so used as to make the scan direction normal to the edge of pattern.

In the semiconductor process in which miniaturization advances more and more in recent years, however, there arise demands for measuring a profile of a two-dimensional pattern including edges in vertical and horizontal directions to manage the process. In such a case, pattern edges lying in both the vertical and horizontal directions exist in an SEM image subject to scanning; the pattern edges in the vertical direction can be clear and can be accurately detected whereas the pattern edges in the horizontal direction become unclear, failing to be detected accurately.

When edges of patterns in the directions of both vertical and horizontal directions exist in the scanned SEM image, the pattern edges in the vertical direction become clear to permit accurate edge detection but the edges in the horizontal direction become unclear to prevent accurate edge detection.

In such a case, since the patterns in the vertical direction are scanned and measured with the raster rotation rendered at 0 degrees and the patterns in the horizontal direction are scanned and measured with the raster rotation rendered at 90 degrees, the scanning needs to be conducted twice.

Depending on the materials used for the recent semiconductor process, however, a phenomenon takes place in which the pattern is caused to shrink under irradiation of an electron beam used for the CD-SEM on a sample or the pattern dimension is caused to increase owing to attachment of contamination generated under the irradiation of the electron beam even with a material free from the shrinkage, giving rise to a change in dimension of the pattern to be measured under the scanning.

In such an event, when the scanning is executed twice where one scanning is normal to a pattern lying in a vertical direction and the other scanning is normal to a pattern lying in a horizontal direction, the amount of pattern shrinkage or the amount of pattern dimension increase due to the attachment of contamination is different for the pattern lying in the vertical direction subject to only one scanning and the pattern lying in the horizontal direction subject to a first scan for a pattern in the vertical direction and a second scan for the horizontal edge detection, thus causing an error between measurement values in the vertical and horizontal directions.

Thus, in the present embodiment, a method is described according to which a signal capable of measurements using edges formed in the vertical, horizontal or other direction is obtained in a single scan.

In order to ensure that highly accurate measurement based on detection of edges formed in a plural directions can be realized through one scan operation, the scanning line direction is set to make a relative angle of, for example, 20 degrees or more to a pattern edge in respect of a pattern having the longitudinal direction of the pattern edge lying in the horizontal direction. Through this method, the amount of signal at the edge portion can increase owing to the edge effect and a change in brightness along the scanning line can be clarified.

An image affected by a change in the scan direction may be titled with respect to an image without a change in the scan direction. In such a case, in order to apply a measurement algorithm in the horizontal direction of an image, the image is rotated by the image processing unit by the same degrees in the direction opposite to the direction in which the scan direction is changed and the measurement is conducted thereafter.

Since the edge in a desired direction on the SEM image can be clear according to the aforementioned method, it is expected that the accuracy of detection of edges extending in plural directions such as the vertical and horizontal directions with a single scanning is improved.

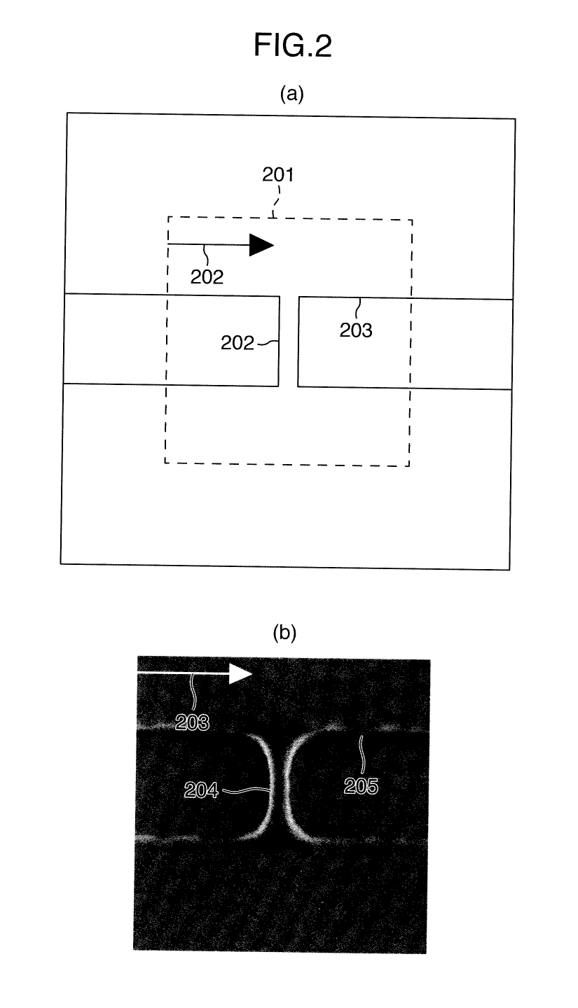

Illustrated at (a) in FIG. 2 is a layout of patterns having edges in the vertical and horizontal directions. By scanning an area designated by 201 in the horizontal direction designated by 202, an SEM image as shown at (b) in FIG. 2 can be obtained.

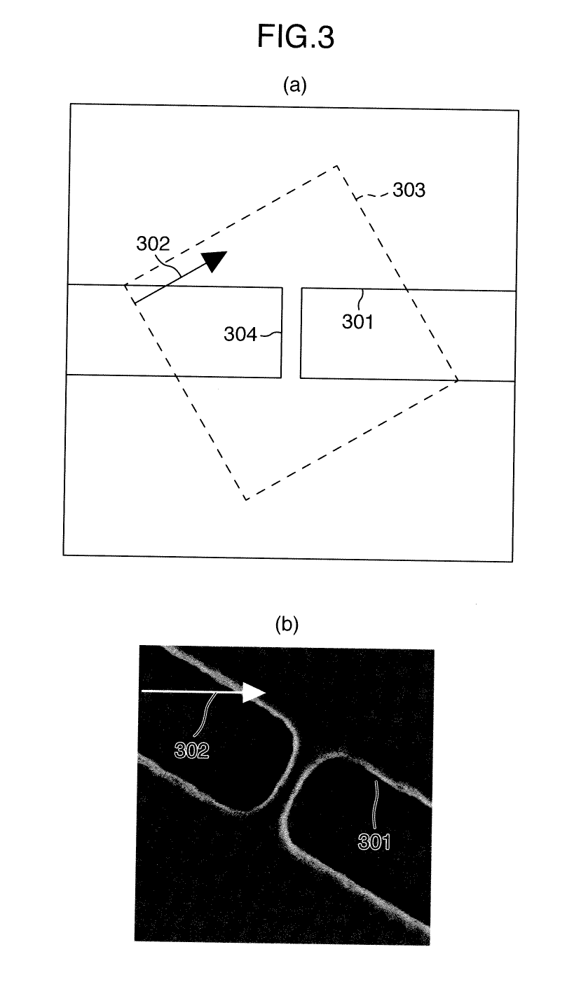

In the SEM image at (b) in FIG. 2, for an edge 204 of the pattern normal to the scan direction 203, the signal amount is large and the edge is displayed clearly in white. On the other hand, it is seen that for an edge 205 of the horizontal direction pattern which is parallel to the scan direction 203, the signal amount is small and a difference in contrast to the peripheral portion decreases, making the edge unclear. To solve this problem, an area 303 is scanned while inclining a scan direction 302 by 20 degrees or more with respect to the pattern 301 of the horizontal direction as shown at (a) in FIG. 3.

By inclining the scan direction 302 by 20 degrees or more with respect to the edge 301 of the horizontal pattern, the edge 301 of the horizontal pattern is not parallel to the scan direction 302 and, as a result, the signal amount of secondary electrons generated from the edge 301 of the horizontal pattern increases. On the other hand, the scan direction 302 with respect to a edge 304 of the vertical pattern decreases from 90 degrees to 70 degrees or less; with the angle between the scan direction 302 and the edge 304 of the vertical pattern rendered 20 degrees or more, the signal amount of secondary electrons generated from the edge 304 of the vertical pattern has no problem.

In other words, by changing the scan direction 302 from 0 degrees, which is parallel to the edge 301 of the horizontal pattern to a range of 20 degrees or more to 70 degrees or less, secondary electrons can be obtained stably at the patterns in both the vertical and horizontal directions and an SEM image showing the edge portion clearly as shown at (b) in FIG. 3 can be obtained.

Since the scanning is conducted by inclining the scan direction 302 by 20 degrees or more with respect to the edge 301 of the horizontal pattern, the SEM image at (b) in FIG. 3 is an image which is rotated in clockwise by 20 degrees or more with respect to the SEM image at (b) in FIG. 2 sought to be obtained originally.

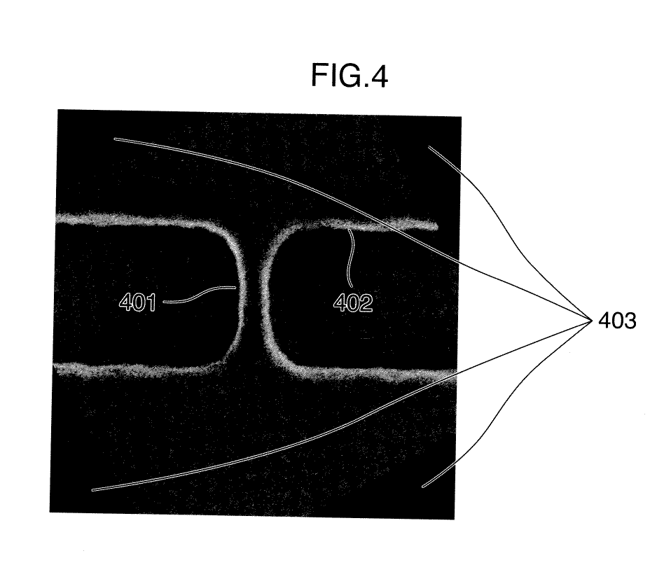

Therefore, the SEM image at (b) in FIG. 3 is rotated by the image processing unit by the same amount as the amount of an angle of the scan direction which is changed from the edge 301 of the horizontal pattern by 20 degrees or more. Through rotation of the image by the image processing unit, the edges can be displayed in the directions originally desired to be obtained such as with an edge 401 of the vertical pattern being in the vertical direction and an edge 402 of the horizontal pattern being in the horizontal direction and an SEM image exhibiting clear edges at both of the vertical and horizontal patterns can be obtained as shown in FIG. 4.

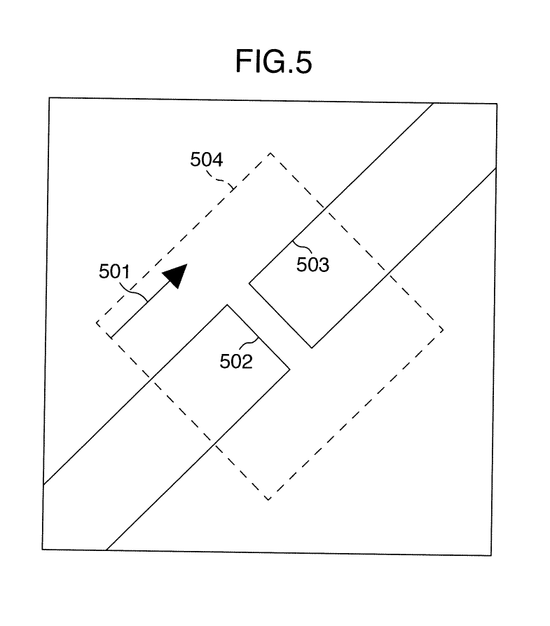

A description has been given in connection with FIGS. 2 to 4 by using the patterns having the edges in the vertical and horizontal directions, that is, in the directions of 90 degrees and 0 degrees but a similar method can be employed even when a pattern is rotated by 45 degrees as shown in FIG. 5. The pattern of FIG. 5 is a layout of the pattern rotated by 45 degrees in counterclockwise with respect to the pattern of FIG. 2.

In order to measure such a pattern, if a method of setting the scan direction normal to the edge is employed, an area designated by 504 is scanned to obtain an image so that an edge 502 in the direction of 135 degrees and the scan direction 501 are normal with each other and an edge 503 in the direction of 45 degrees and the scan direction 501 are parallel with each other.

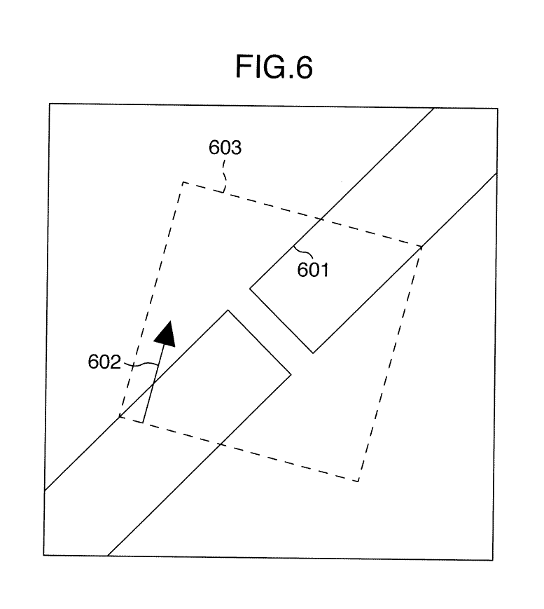

On the other hand, in a method of inclining the scan direction with respect to edges, an area 603 in which a scan direction 602 is inclined by 20 degrees or more with respect to an edge 601 lying in the direction of 45 degrees is scanned as exemplified in FIG. 6. By rotating the scan direction in this manner, the edge 601 lying in the 45-degree direction is not parallel to the scan direction 602 and a brightness difference on one scanning line between the edge portion and the other portions can be made clear.

Incidentally, when the so-called raster rotation of rotating the scan direction is carried out, the signal inputted to the X or Y direction deflection coil (or deflection electrode) is a composite of the component of rotation. In this case, the magnification may sometimes change depending on the direction of rotation.

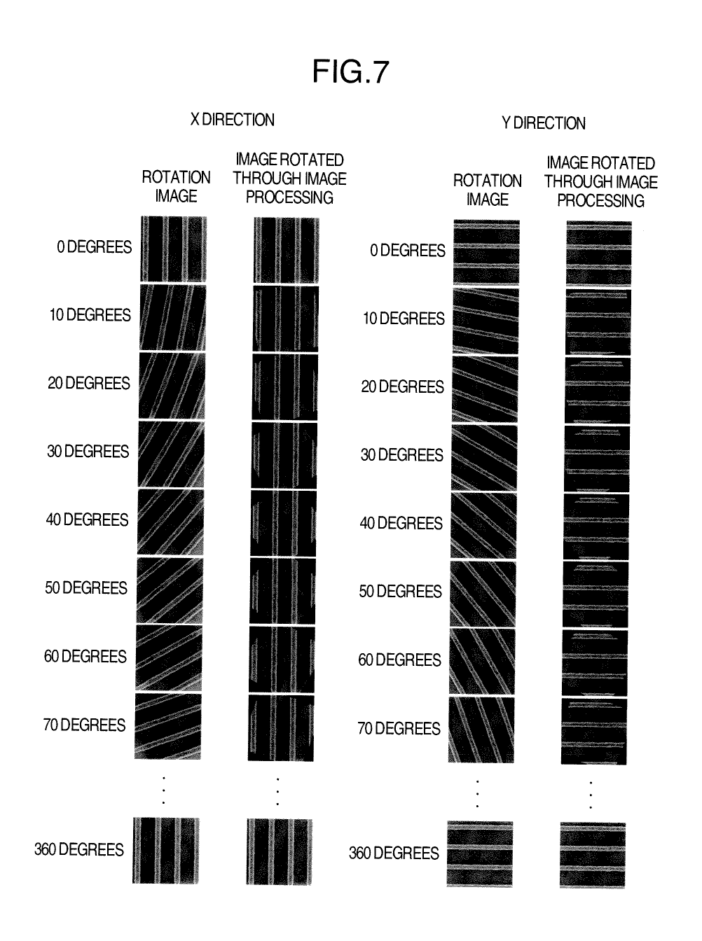

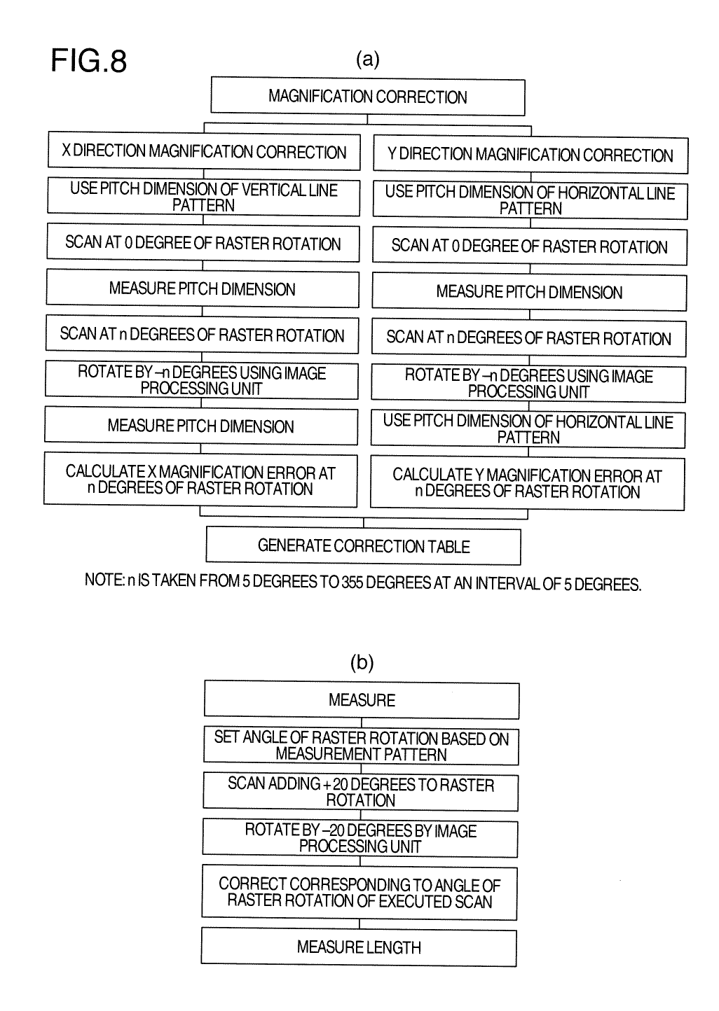

A method of determining a correction coefficient for appropriately correcting such a change in magnification is described below. In the present embodiment, in order to determine the correction coefficient, a pitch dimension of a vertical or horizontal dense line pattern is measured and the measurement value is compared with a reference value to obtain a ratio or a difference. For execution of the comparison, a dimension value when the raster rotation is not carried out is made to be a reference and the reference value is compared with a dimension value when the raster rotation is carried out. The comparison is conducted at intervals of a predetermined rotation angle and correction coefficients at respective rotation angles are calculated. FIGS. 7 and 8 are the figures to explain the method of calculating the correction coefficients (magnification errors).

In the present embodiment, using images obtained with the scanning lines (0 degrees) parallel to the X direction and the Y direction as reference the magnification error value or the correction coefficient is calculated by determining a difference or a ratio between the reference and an image when the scan direction is rotated by 10 degrees, as exemplified in FIG. 7. At that time, since an image obtained after raster rotation is rotated, the rotation angle is corrected through an image processing. In an example of the FIG. 7, images obtained by scanning the same spot on the sample when the raster rotation is actually executed and not are arranged with the directions of pattern edges aligned.

According to this method, even when a raster rotation of 360 degrees is used, a vertical line pattern is displayed in the vertical direction as shown in FIG. 7. Therefore, even without rotation of the wafer, the pitch dimension with the raster rotation being used can be measured so that with the reference of a pitch dimension at 0 degree, a magnification error with the raster rotation being used can be corrected. Similarly, a pitch dimension in the Y direction can be measured using a line pattern in the horizontal direction and, therefore, a correction for magnification when the raster rotation is used can be implemented easily.

Next, procedures from correction to measurement are described along with a flowchart of FIG. 8.

First, a magnification correction is conducted as shown at (a) in FIG. 8. In order to correct the magnification in the X direction, the pitch dimension of a vertical line pattern is measured at 0 degrees of the raster rotation. Scanning is carried out using the same pattern with the scan direction rotated by 5 degrees by the raster rotation. The image is rotated using the image processing unit by the same angle as the angle rotated by the raster rotation. The pitch dimension of the vertical line pattern is measured. A magnification error from that at 0 degrees of the raster rotation is determined.

The above operation of magnification error is executed at every 5 degrees up to 355 degrees. The magnification in the Y direction is similarly corrected. In correction for magnification in the Y direction, the pitch dimension in the Y direction is measured using the pitch of a horizontal line pattern and the raster rotation is set at every 5 degrees up to 355 degrees similarly to the magnification correction in the X direction. The magnification errors acquired at every 5 degrees up to 355 degrees in the X and Y directions are saved as correction coefficients in a table.

Incidentally, a ratio between a measurement value obtained at 0 degrees and a measurement value obtained at another angle may be stored as a coefficient in the correction table so that a measurement value obtained at an angle other than 0 degrees may be multiplied or divided by the coefficient. Otherwise, a difference between the measurement value obtained at 0 degrees and a measurement value obtained at another angle may be stored and a value concerning the difference may be added to the measurement value obtained at an angle other than 0 degrees or may be subtracted therefrom.

Actual measurement is carried out as shown at (b) in FIG. 8. A user confirms a pattern to be measured and sets a position (coordinates) and a magnification of the raster rotation such that the pattern can be included in a FOV. The device proceeds with scanning after adding 20 degrees to the raster rotation set by the user. An obtained image is rotated by the image processing unit by the same angle as that added by the device and is then displayed.

At this time, magnification correction data is provided as incidental information to the image. The table generated when the magnification error is determined is used for the magnification correction data; based on the angle of the raster rotation set by the user and the angle added by the device a coefficient, which corresponds to the angle of the raster rotation when the actual scan is carried out, is used.

When black portions at four corners of FIG. 4 affect the length measurement, the following measure should be taken. Normally, an SEM image is composed by a quadrangle such as a square or a rectangle. Accordingly, through rotation of the SEM image by the image processing unit, areas with no information are generated at the four corners 403 of the SEM image.

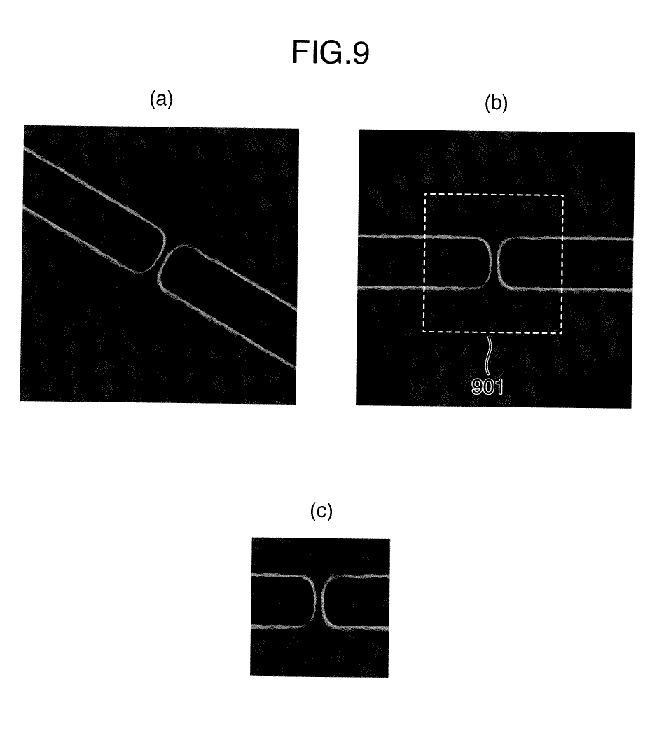

In such a case, scanning is executed at a magnification half of the designated magnification to obtain an image as shown at (a) in FIG. 9. At that time, in order to prevent degradation of image quality an image is acquired with greater pixels of 1024×1024 pixels for a device adapted to typically form a scanning image of 512×512 pixels. Then, the size of the scanning area and the number of the scanning lines are also doubled as compared to that for a scanning image of 512×512 pixels. Thereafter, as shown at (b) in FIG. 9, the image is rotated by the image processing unit. At (b) in FIG. 9, an area 901 at the center 512 pix×512 pix is cut out and an SEM image of 512 pix×512 pix as shown at (c) in FIG. 9 can be produced.

FIG. 11 is a diagram for explaining an example of design data of a semiconductor pattern. The design data is read out of either the design data memory portion 1006 in the data management unit 1003 of measurement system exemplified in FIG. 10 or the external memory medium and is used. In the present embodiment, a description is given for an example where the scan direction is changed based on predetermined conditions and its rotation angle is set as a scanning condition when a recipe of the scanning electron microscope is set in the design data. The setting is carried out in the recipe generator portion 1004.

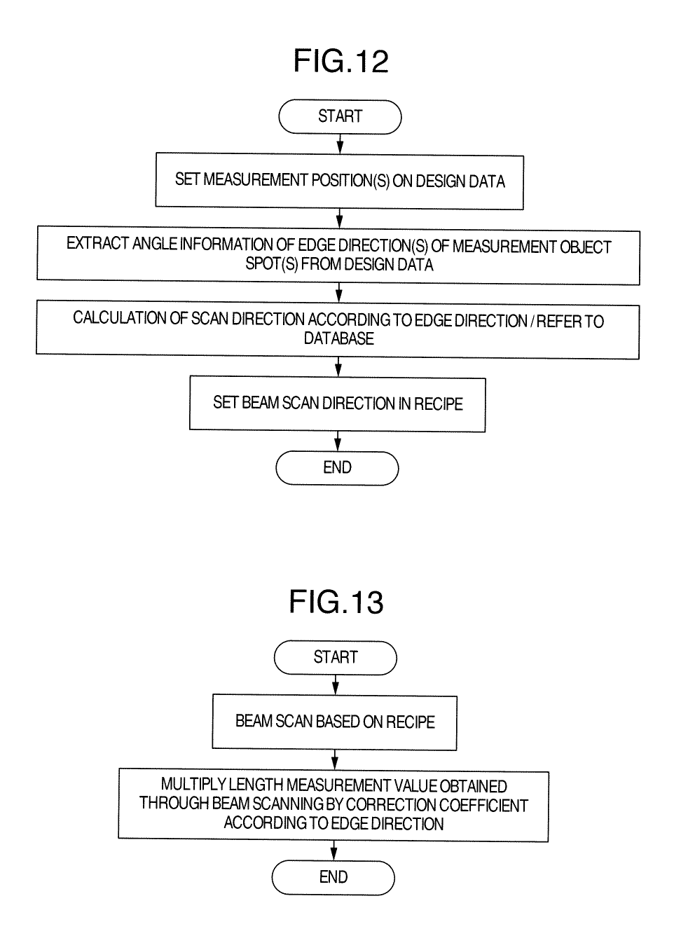

FIG. 12 is a chart for explaining procedures for automatically determining the beam scan direction based on settings of a measurement spot(s) on the design data. First, a measurement position(s) is set on the design data. The design data is displayed as a line diagram as shown in FIG. 11 and an operator designates a measurement spot(s) on the diagram. FIG. 11 is a diagram explaining an example where two measurement spots 1101 and 1102 are designated. Next, angle information of the edge direction(s) of measurement object spot(s) is extracted from the design data. In this case, a process is executed for reading angle components of two line segments representing dimension measurement objects out of the design data. Subsequently, by making reference to an operation of the scan direction according to the edge direction or the database stored in advance the scan direction is determined. In the example of FIG. 11, the two measurement spots 1101 and 1102 are directed to 90 degrees and 45 degrees (when letting the horizontal direction be 0 degrees), respectively. In this case, scanning line directions are calculated to make relative angles of predetermined values or more to the two measurement spot edges. When determining the scanning line direction making a relative angle of 20 degrees or more, the scanning line direction needs not be set within a range of 25 degrees to 65 degrees at which a relative angle to 45 degrees is 20 degrees, or within a range of 70 degrees to 110 degrees, at which a relative angle to 90 degrees is 20 degrees; an operation is performed to set the scanning line direction to 65 degrees or more and 70 degrees or less or 25 degrees or less and 110 degrees or more (excluding 205 degrees to 245 degrees and 250 degrees to less than 290 degrees).

In the case of the present embodiment, the scanning line direction can be set to an arbitrary direction of 65 degrees or more and 70 degrees or less or 25 degrees or less and 110 degrees or more (excluding 205 degrees to 245 degrees and 250 degrees to less than 290 degrees); for example, if the measurement accuracy in the plane is intended to be improved by making the relative angles to a plurality of patterns equal, the scanning line direction may be set to a direction (157.5 degrees) normal to 67.5 degrees representing an intermediate angle between 45 degrees and 90 degrees. Through this, the relative angles become identical to two edges and improvement of measurement accuracy for plural measurement objects can be expected.

Also, instead of deciding the scan direction through operation, a database determining given conditions in advance may be prepared and scan directions adaptable for edge directions of plural measurement spots may be read out of the database.

The scan direction of the beam determined as above is stored in the memory medium associated with the recipe generator portion 1004 to finish the recipe setting.

While in the present embodiment an example is described where relative angles to edge directions of two measurement spots are set to a predetermined value or more, the relative angles to edges of all measurement spots cannot sometimes be set to the predetermined values or more as the number of measurement spots increases. In this case, an error indicating this can be displayed to enable the operator to proceed with appropriate measures such as changing the magnification, making the number of measurement spots appropriate, or the like in consideration of measurement accuracy.

According to the present embodiment, a difference in brightness on a scanning line can be clarified even when a plurality of measurement object spots having different edge directions are present in one FOV by setting the scan direction such that a plurality of predetermined angle ranges associated with edge directions of a plurality of measurement object spots being set are excluded.

FIG. 13 is a chart for explaining procedures when beam scanning is conducted actually based on a set recipe. By multiplying the value of length measurement obtained through beam scanning by a correction coefficient determined through the procedures of FIG. 8, a length measurement value deemed as a true value can be calculated.

### Embodiment 2

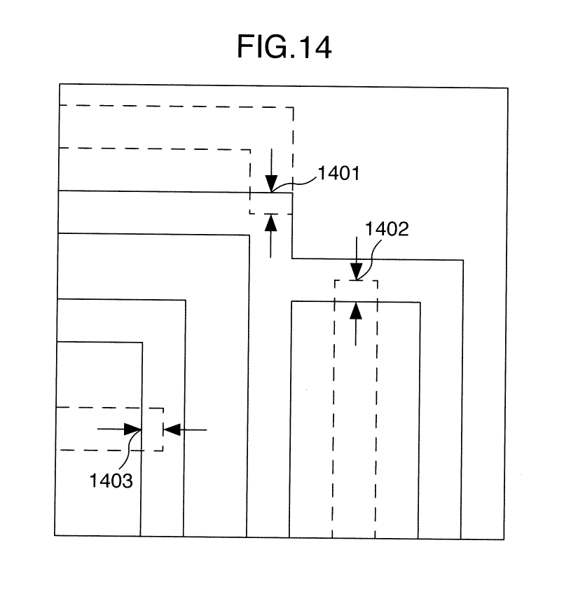

Another method of realizing appropriateness of the scan direction of an electron beam is described hereinafter. FIG. 14 is a diagram for explaining design data of patterns formed through double-patterning (double exposure) technique. The double patterning is a lithography method in which design data for one layer is divided for two masks and a plurality of exposure operations are conducted and the k1 value can be increased by the division of design to reduce the degrees of difficulties in lithography. As an example, a one-layer patterning may be completed on a wafer by repeating a first patterning and a fabrication 1, and, then, a second patterning and a fabrication 2. The pattern exposure is conducted with an optical exposure unit (stepper).

A pattern in a solid line in FIG. 14 is the pattern formed by the first patterning (hereinafter, the first pattern) and a pattern in a dotted line is the pattern formed by the second patterning (hereinafter, the second pattern). As illustrated in FIG. 14, an overlapped area is provided between the first and second patterns to assure connection therebetween. Such an overlapped area is an important evaluation object in the design data for deciding whether the pattern divided to two are connected together properly. By evaluating the direction of interruption between patterns at measurement spots 1401, 1402, and 1403, a decision can be made as to whether interconnection between the first and the second patterns is actually completed.

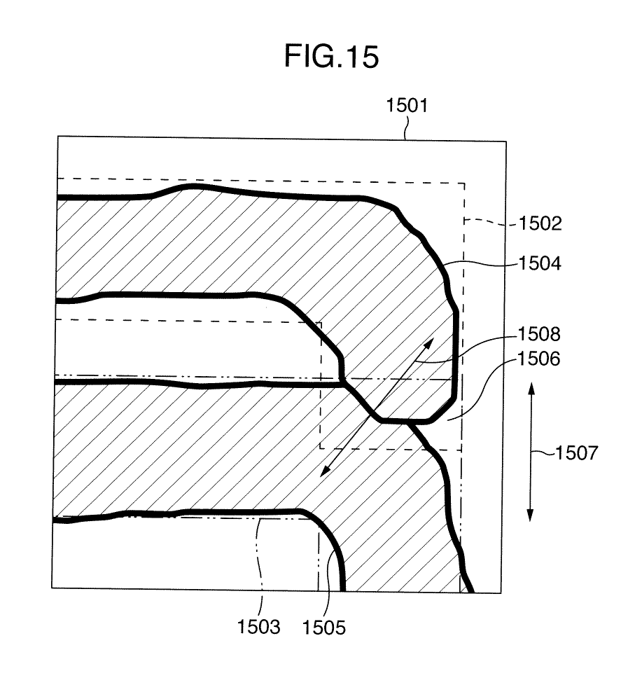

On the presumption that the patterns decrease compared to the design data and an interruption develops between the patterns, the measurement direction can conceivably be set in arrow directions in the figure. But various forms can be considered as pattern deformation and the direction of interruption is considered to be non-uniform. For example, for the measurement spot 1401, a deformation as exemplified in FIG. 15 can be considered. FIG. 15 is a diagram for explaining an example of an acquired image of the vicinity of the measurement spot 1401 in FIG. 14 at a higher magnification than that in the example of FIG. 14. In an FOV 1501, a first pattern 1505 and a second pattern 1504 are displayed. Further, the design data 1503 of the first pattern and the design data 1502 of the second pattern are displayed in an overlapped fashion.

Disposed between the design data 1503 of the first pattern and the design data 1502 of the second pattern is an overlapped region 1506 for assuring interconnection between the two patterns. In the case of the thus formed pattern, setting the scan direction in a measurement direction 1508 may be better than in a measurement direction 1507. This is because it is conceivable that the direction of interruption is different depending on a pattern deformation during exposure or the like. For example, with the scanning line direction set in a direction normal or nearly normal to the interruption direction, the status of interruption becomes unclear; there is a possibility that even when the two patterns are disconnected from each other, in an SEM image they appear to be connected.

In the present embodiment, a method is proposed in which pattern profiles are obtained through simulation and the scanning line direction is determined in accordance with a contour of the first pattern and a contour of the second pattern which are obtained through simulation in order to appropriately evaluate an interrupted portion. For simulation, an existing simulation technique can be used.

In the present embodiment, the scan direction is calculated based on pattern profiles obtained through lithography simulation. To the lithography simulation technique per se, an existing technique can be applied.

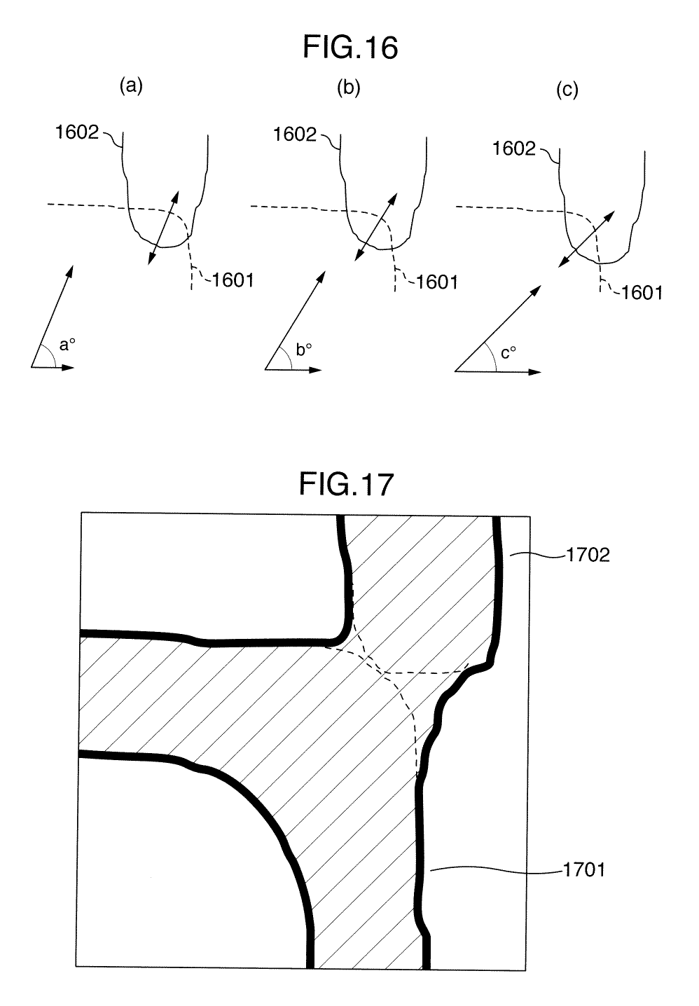

FIG. 16 is a diagram for explaining types of the connection relation between the first pattern and the second pattern. (a), (b) and (c) in FIG. 16 are diagrams for explaining examples of profiles of a contour 1601 of the first pattern and a contour 1602 of the second pattern generated through simulation. These three simulation results are different in status of overlapping of the first pattern and the second pattern because of differences in production conditions and design conditions of the individual patterns. Depending on the degree of deformation of the two patterns, the two cannot appropriately be connected together and conceivably breaking of wire would occur. That is, as exemplified in FIG. 17, a white band cannot be confirmed at the connection portion and it is conceivable that the two patterns are not actually connected together as exemplified with the dotted line even if connection is seen apparently. In order to properly evaluate such connection/disconnection statuses, the scanning line direction is preferably set along the direction of interruption to make the disconnection explicit.

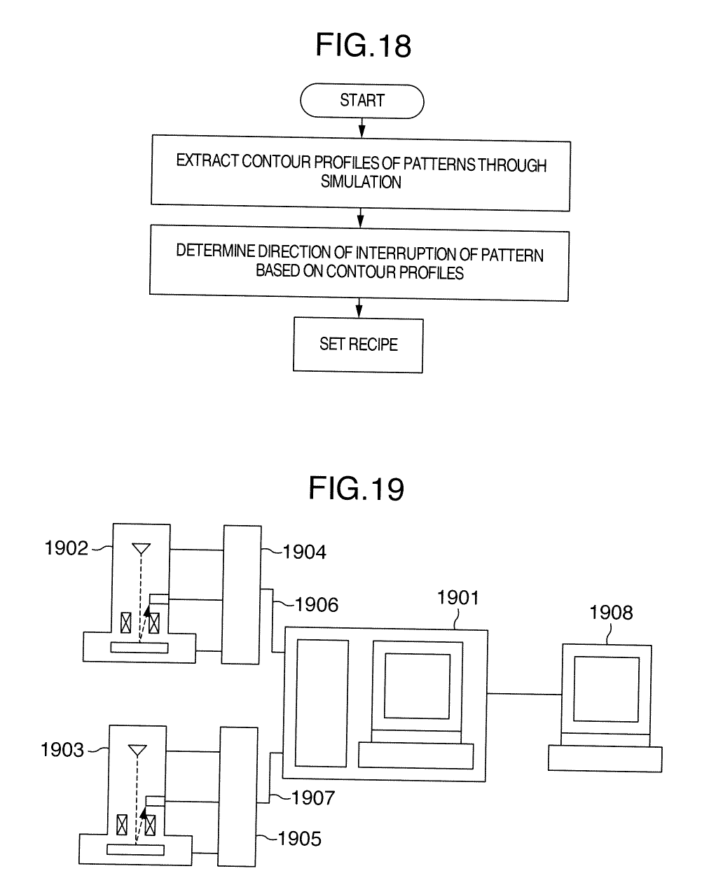

The interruption direction would, however, conceivably change widely in accordance with pattern deformations. When the interruption direction is considered to be normal to the connection portion of the two patterns (a portion closest to the other pattern if spaced apart), directions of a degrees, b degrees, and c degrees with respect to the horizontal direction are considered to be interruption directions in examples shown at (a), (b), and (c) in FIG. 16, respectively. Accordingly, in the present embodiment, the interruption direction is determined from the pattern contour profiles obtained from the simulation result and the scan direction is set such that the direction of scanning line is parallel to the interruption direction. Illustrated in FIG. 18 is a flowchart for explaining the flow of determining contour profiles of two patterns, determining the interruption direction (scanning line direction) from the contour profiles, and then registering these conditions in a recipe by the recipe generator portion 1004.

With the construction as above, the connection status between patterns formed through double patterning can be evaluated properly based on setting of the appropriate scan direction. In a conceivable method for determining the interruption direction, contours of two patterns, for example, are approximated by curves, center points of the curves are determined based on curvatures of the curves, and a straight line connecting the two center points determined for the two patterns is set as the scanning line direction.

In addition, it is conceivable that the scanning line direction is in a direction normal to a straight line connecting two intersects formed when part of two contour lines overlap with each other. Further, it is conceivable that a point on the contour line closest to the other pattern (or intruding most deeply to the other pattern) is extracted, a tangential line of the contour line passing through that point is determined, a straight line is obtained by arithmetic averaging of tangential line direction angles of contour lines extracted for the two patterns, and a direction normal to the thus obtained straight line is the scanning line direction. Furthermore, it is conceivable that, when the determined scanning line direction is other than rotation angles settable by the device, a rotation angle settable by the device and closest to the determined scan direction is set.

Further conceivably, the manner set forth in connection with embodiment 1 is utilized to rotate the scan direction such that the scanning line direction is not parallel or not nearly parallel to interruption directions of the plural measurement spots when a plurality of measurement spots are included in an FOV.

In this case, the scan direction can be defined by an angle determined such that all of its relative angles to the scanning line directions obtained for respective measurement spots are within a predetermined range. A predetermined angle range centered at the scan direction angle is determined in respect of plural measurement spots, an overlapping range of the plural angle ranges is determined, and an angle within the overlapping range can be set as a scan direction. Incidentally, at that time, the center angle of the overlapping angle range can be set as a scan direction or a rotation angle settable by the device within the overlapping range can be selected to be a scan direction.

A system configuration for determining the scan direction of an electron beam based on exposure simulation for a semiconductor and the like is exemplified in FIG. 19. In FIG. 19, a system is exemplified in which a plurality of SEM's are connected around a data management unit 1901 at the center. Specifically in the present configuration, an SEM 1902 is mainly adapted to perform measurement and inspection of patterns of a photo-mask and/or a reticle which are used for a semiconductor exposure process and an SEM 1903 is mainly adapted to perform measurement and inspection of a pattern transcribed onto a semiconductor wafer by exposure using the photo-mask and the like. The SEM 1902 and the SEM 1903 do not differ significantly from each other in terms of the basic construction of an electron microscope but they are constructed to meet differences in sizes of semiconductor wafer and photo-mask and differences in tolerance to charge-up.

The SEM 1902 and the SEM 1903 are connected to control units 1904 and 1905, respectively to carry out control necessary for SEM's. In each SEM, an electron beam emitted from an electron source is focused by plural stages of lenses and a focused electron beam is scanned on a sample one-dimensionally or two-dimensionally by a scan deflector.

Secondary electrons (SE's) or backscattered electrons (BSE's) emitted from the sample under the electron beam scanning are detected by a detector and stored in a memory medium such as a frame memory in synchronism with scanning by the scan deflector. Image signals memorized in the frame memory are accumulated by an operation unit equipped in each of the control units 1904 and 1905. The scanning by the scan deflector can be conducted over any size, at any position, and in any direction.

The control as above and the like are conducted in the control units 1904 and 1905 of the individual SEM's and an image and a signal obtained as a result of the scanning of the electron beam are sent to the data management unit 1901 via communication lines 1906 and 1907. While, in the present example, the control unit for controlling the SEM and the data management unit for performing measurement based on the signal obtained by the SEM are described as being separate from each other but it is not limited thereof; the device control and the measurement processing may be executed collectively in the data management unit or the SEM control and the measurement processing may be executed in each control unit.

Then, the aforementioned data management unit or the control unit stores a program for execution of the measurement processing and measurement or operation is performed in accordance with the program. Further, in the data management unit, design data of photo-masks used in semiconductor fabrication process (hereinafter, simply referred sometimes to as masks) and wafers are stored. The design data are expressed in a GDS format or an OASIS format, for example, and stored in a predetermined format. The kind of the design data does not matter, provided that software for displaying the design data can display one in its format type and handle it as graphics data. In an alternative, the design data may be stored in a memory medium provided separately from the data management unit.

The data management unit 1901 is provided with the function to generate a program (recipe) for controlling the operation of SEM based on design data of a semiconductor, thus functioning as a recipe setting portion. More specifically, programs are generated which are used for setting positions where processes necessary for the SEM are executed such as desired measurement spots, auto-focus points, automatic astigmatism correction points, or addressing points on design data, contour line data of pattern, or design data with simulation applied so that the sample stage, the deflector, and the like of the SEM are controlled automatically based on the setting.

The data management unit 1901 is connected with a simulator 1908 for simulating the result of a pattern based on the design data and the data management unit 1901 incorporates a memory medium adapted to convert a simulation image to which optical simulation, resist profile simulation, and the like are applied by the simulator 1908 into a format of GDS or the like and to register it.

In order to determine the scan direction of the electron beam based on the simulation image converted to the predetermined format, a plurality of measurement objects are selected in the simulation image and the scan direction is so determined as to make a predetermined angle with edges of the plural portions of objects for length measurement. A sequence may be provided, for example, in which the scan direction is set to 45 degrees when two kinds of patterns exist: one of which has an edge in the X direction (0-degree direction) and the other of which has an edge in the Y direction (90-degree direction) in the design data (layout data). For example, through GDS formatting, angle information of each line segment can be obtained and the scanning line direction may be determined by using the angle information. In this case, a range in which each line segment makes, for example, 20 degrees or more and 70 degrees or less with respect to the scan direction is determined by operation and its value is registered in the recipe. According to the present embodiment, the scan direction to be determined based on an actual device can be determined without using the actual device.

### REFERENCE SIGNS LIST

101 cathode
102 first anode
103 second anode
104 primary electron beam
105 condenser lens
106 objective lens
107 wafer
108 deflection coil
109 deflection controller
110 secondary electrons
111 secondary electron detector
112 amplifier
113 CRT

1. An image formation method of scanning a charged particle beam on a sample and forming an image based on charged particles obtained by said scanning, comprising:
recognizing directions of edges a plurality of measurement objects on said sample have;
rotating a scanning line of said charged particle beam such that said direction of the scanning line differs from said directions of said plurality of edges;
scanning said rotated scanning line on an area in which said plurality of measurement objects are contained; and
forming an image based on charged particles obtained on the basis of said scanning.

2. The image formation method according to claim 1, wherein said scanning line direction is rotated in such a manner that said scanning line direction of the charged particle beam makes a relative angle of 20 degrees or more and 70 degrees or less with respect to line segment directions of said edges the plurality of measurement objects have.

3. The image formation method according to claim 1, further comprising measuring dimensions of said measurement objects using said image being formed.

4. The image formation method according to claim 3, wherein dimension values of said measurement objects are derived by multiplying or adding a correction coefficient or a correction value according to an angle of said rotation by or to measured values of said measurement objects.

5. The image formation method according to claim 1, wherein rotating said scan direction is further comprising:
setting said measurement objects on design data of said sample;
acquiring information concerning directions of edges of the set objects based on said setting; and
rotating said scan direction based on said information.

6. An image formation device for forming an image based on charged particles obtained by a charged particle beam device, comprising an operation unit for:
recognizing directions of edges a plurality of measurement objects on a sample area scanned by said charged particle beam device have; and
operating a direction of a scanning line of said charged particle beam such that said direction of the scanning line differs from said directions of the plurality of edges.

7. A measurement method for measuring a pattern formed through a double exposure process with an optical exposure device using a signal obtained based on scanning of a charged particle beam, comprising:
simulating a first pattern profile formed through a step of a first light exposure of said double exposure and a second pattern profile formed through a second light exposure process after said exposure process based on design data;
determining a direction of interruption of a connection portion of said first pattern and second pattern from the result of said simulation; and
setting a scanning line direction of said charged particle beam in said direction of interruption or a direction determined by the direction of interruption.
